(19) United States
(12) Patent Application Publication
(10) Pub. No.: US 2014/0067552 A1
(43) Pub. Date: Mar. 6, 2014

(54) ONLINE ADVERTISING SCORING

(71) Applicant: Minds + Machines, Santa Monica, CA (US)

(72) Inventor: Frederick R. Krueger, Santa Monica, CA (US)

(73) Assignee: Minds + Machines, Santa Monica, CA (US)

(21) Appl. No.: 13/781,440

(22) Filed: Feb. 28, 2013

Related U.S. Application Data
(60) Provisional application No. 61/604,348, filed on Feb. 28, 2012.

(51) Int. Cl. G06Q 30/02

(52) U.S. Cl. CPC G06Q 30/0273
USPC 705/14.69

(57) ABSTRACT

Described is a system for online advertising buying. Components of an online ad (the title, the ad copy, the ad image or video, the targeting, and/or the landing page) may be independently scored by the system against a baseline. By giving marketers quantitative feedback on the individual components of an advertising campaign—not just on the overall ads running—this new “scoring” system win allow them to make much more educated choices on individual component types.

### RELATED APPLICATIONS

This patent claims priority to and the benefit of co-pending U.S. Provisional Application No. 61/604,348 to Frederick R. Krueger, which is incorporated herein by reference for all purposes.

### TECHNICAL FIELD

The present invention generally relates to the field of online advertising, and more specifically, the the field of buying online advertising.

### SUMMARY OF THE INVENTION WITH BACKGROUND INFORMATION

Traditionally, online marketers have used tools such as Google Adwords and self-service platforms such as the Facebook Advertising platform to build and run a class of online advertisements that are primarily text based, but which can contain an image. Typically, each such ad can be broken out into the following five ad components:

(1) The title of the ad, which is typically 80 characters or less;

(2) The ad copy, which is typically a string of approximately 140 characters;

(3) An image which optionally accompanies the ad, which frequently has a size of 100 by 80 pixels;

(4) A targeting group, which can comprise a gender, location, keywords and other variables; and

(5) A destination URL, or landing page, which determines where the user goes when they click on the ad.

Experienced marketers know that they may need to try hundreds of combinations of these five components in order to find the best performing advertisement.

Furthermore, even when high performance ads are identified, there is a question of what is the optimal cost per click rate to pay for these ads. Most marketers have a very poor idea of what is the optimal cost per click to bid on any individual campaign. Increasing the cost per click increases the volume of ad impressions, but it also lowers the profitability to the marketer. Systems like Google AdWords or Facebook do not give any specific direction on what the optimal cost per click bid should be for any particular campaign.

Some existing systems, in particular systems targeted at automating the Facebook ad system, do facilitate testing by allowing the marketer to pick and choose from different pre-loaded images, ad copy, and other assets, to build ad campaigns. These ad campaigns are then set to run, and the least performing ones are shut down relatively quickly. But these existing systems evaluate each ad as a whole—they do not evaluate each component of each ad.

Until now, a system has not existed that would evaluate the performance of each different component of an ad. The disclosed system allows a marketer to test out different components (different images, different titles, different ad copy), leading to optimized results. The disclosed system also identifies the optimized cost per click bid by campaign.

Generally stated, the described system is an online advertising buying apparatus and method. Components of an online ad (the title, the ad copy, the ad image or video, the targeting, and/or the landing page) may be independently scored by the system against a baseline. By giving marketers quantitative feedback on the individual components of an advertising campaign—not just on the overall ads running—this new “scoring” system allows them to make much more educated choices on individual component types.

The efficiency of online advertising purchases may be improved by the disclosed system for scored component analysis. In addition to scoring, the disclosed system may automatically assemble and test ads from the different components, and may score the overall conversion of all possible combinations of these components. These conversion scores may generate an optimized cost per click for each ad in a way that maximizes the expected conversions for the advertiser.

The disclosed system may apply to any form of online advertising, including banner advertising, display advertising on popular social networks such as Facebook, and mobile advertising.

### BRIEF DESCRIPTION OF THE DRAWINGS

FIG. 1 is an illustrative display screen presented by one embodiment showing scores for different ad copy units for a particular campaign;

FIG. 2 is an illustrative display screen presented by one embodiment showing scores for a plurality of image components;

FIG. 3 is an illustrative display screen presented by one embodiment showing scores for a plurality of targeting groups;

FIG. 4 is an illustrative display screen presented by one embodiment showing a selection of top performing ads; and

FIG. 5 is a functional block diagram illustrating a computing device that may be used to implement embodiments of the invention.

### DETAILED DESCRIPTION

The embodiments illustrated in the Figures show an ad creation and ad buying system. In a preferred embodiment, the disclosed system provides a score for each component of one or more advertisements, and determines an optimized cost per click bids for each ad.

This disclosure first considers the problem of scoring the individual ad components. For the purpose of this disclosure, an online ad includes five ad components, a title; ad copy; an image; a target group; and a destination. However, those skilled in the art will appreciate that those five ad components represent the five most common components of online ads today; deviations in the number of particular ad components or their individual meanings can be made without deviating from the spirit and scope of the invention.

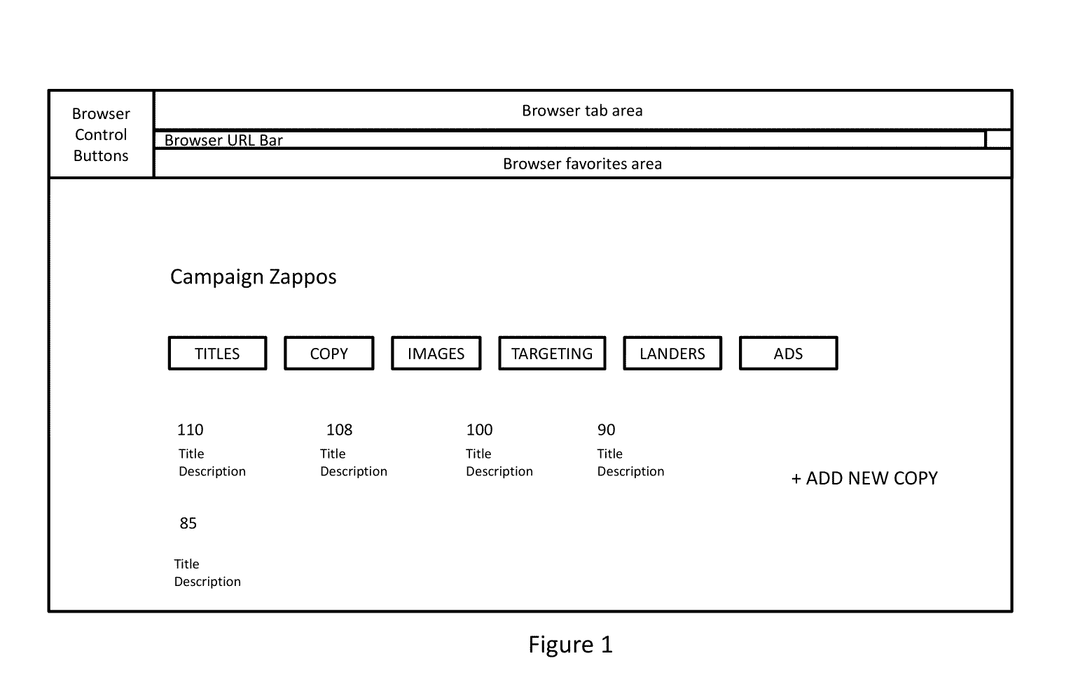

FIG. 1 illustrates one embodiment of an interface that displays the scores for different ad copy units for a particular campaign in one embodiment of the disclosed system. As illustrated in FIG. 1, the baseline ad copy is scored 100. Other ad copy is scored either higher or lower than the baseline copy, depending on whether the other ad copy helps or hinders performance compared to the baseline copy. (In the event the other ad copy receives the same score, the other copy could also receive a score of 100.)

Since the disclosed system may provide for the scoring of copy as a function of performance, this enables the marketer to adjust copy accordingly. With other variables taken out of the system, the marketer can focus specifically on creating the most compelling message. All the marketer does is input copy, and the system scores it, and either uses it (if it is more effective than the baseline copy) or does not.

Similarly, the disclosed system may provide for the scoring of one or more image components of the ad. (These image components, like other components of ads scored according to the disclosed system, may be potential—i.e., not yet used in an ad—or actual—i.e., currently used in an ad.)

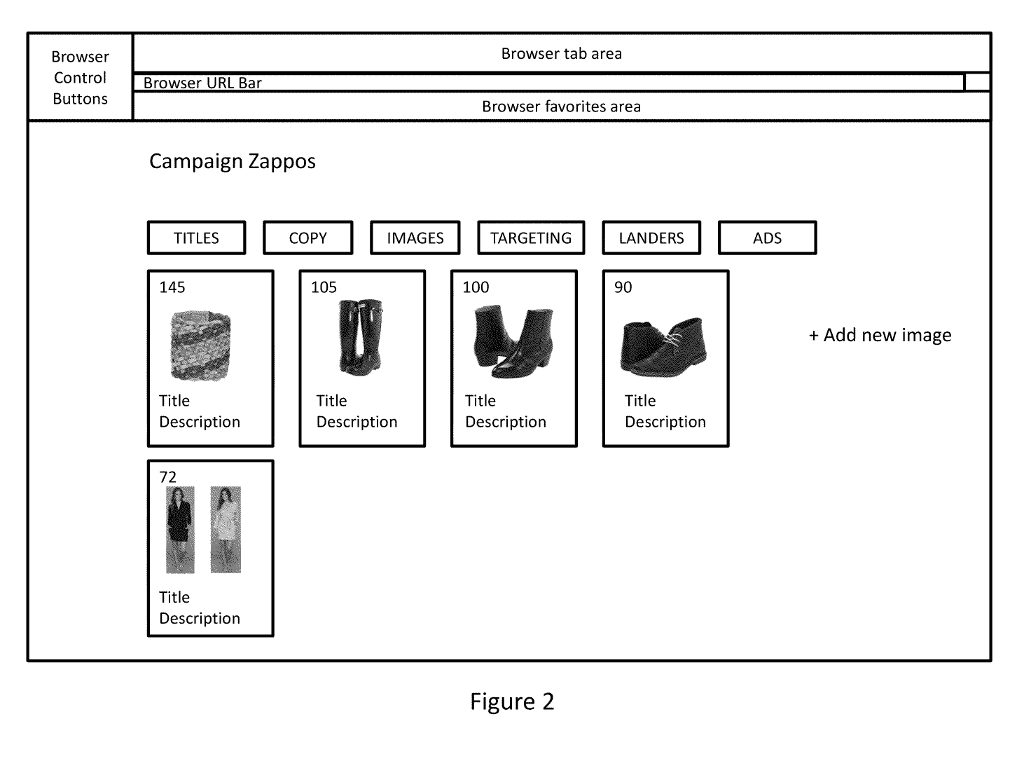

FIG. 2 illustrates one embodiment of an interface that displays the scores for a plurality of image components in one embodiment of the disclosed system. As shown in FIG. 2, the image with the score of 100 is a baseline image. The relative conversion of the other images is either higher or lower than 100, with higher scores indicating greater effectiveness.

As with ad copy, the image component scores help the marketer determine which images have the highest conversion rates. It is well known that the choice of image can make dramatic changes in a conversion rate for an ad—but now, for the first time, the disclosed system provides a quantitative guide indicating which images work best for a specific campaign.

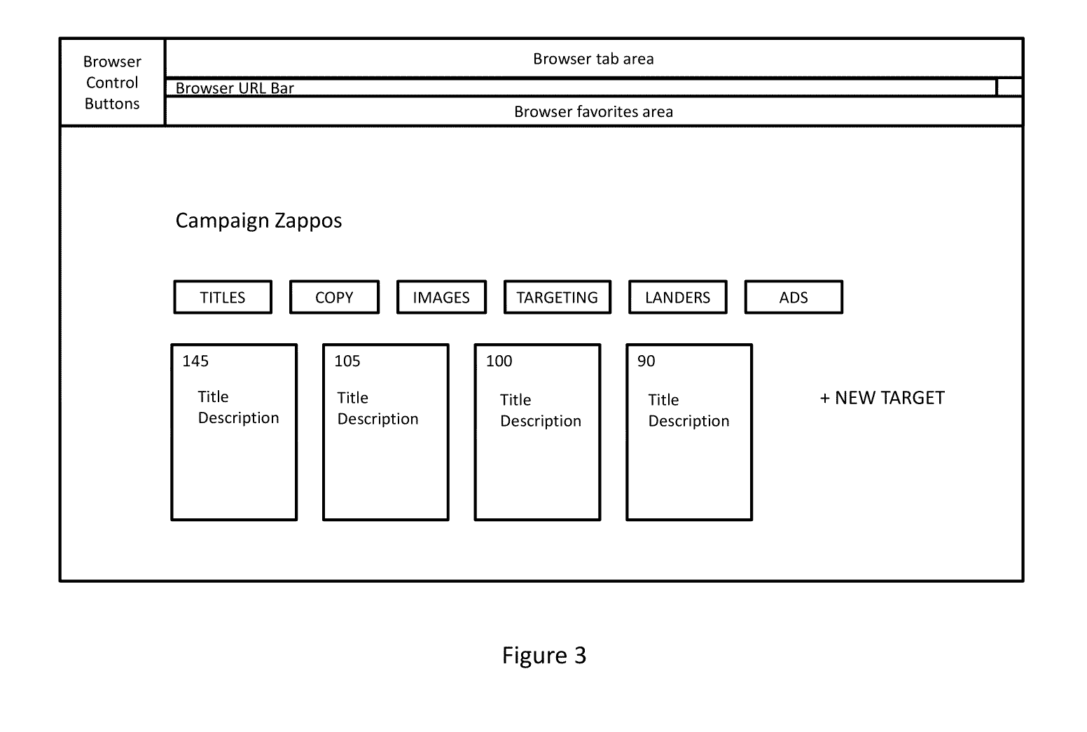

FIG. 3 illustrates another embodiment of an interface displaying the scores for a plurality of targeting groups. As shown in FIG. 3, the baseline targeting group has a score of 100, while some targeting choices may have higher conversions, and some may have lower, as indicated by their respective scores.

In one embodiment, the interface for entering the titles of the ads is largely similar to the interface for ad copy (as illustrated above). In various embodiments, the interface for the landing page—which may consist of a single URL (web address) of the landing page that the ad is redirected to—may be similar to one or more of the interfaces illustrated above.

### Component Groups

In one embodiment of the disclosed system, ad components can be grouped by assigning them one or more group tags. Each tag indicates that the ad component should be used with another component having the same tag. For example, there could be two photos tagged “accessories”, and three titles with that same tag. The system would know not to use any other titles with the two images other than titles having the “accessories” tag.

### Scoring a Given Ad Combination

The disclosed system may allow a marketer to automatically combine multiple ad components into individual ads, and to test each ad's performance.

Typically, marketers have one or more measures of performance, typically referred to as “actions”. Without limitation, an action may be, for example, any one of the following: providing an email address, filling out a form, downloading an application on a mobile device, or purchasing one or more items from an e-commerce site.

Each marketer's goal is to lower his overall cost per action or “CPA”. The inverse of the CPA is the amount of Actions per Dollar, or “APD”. Minimizing the CPA is equivalent to maximizing APD.

Currently most advertising sites such as Google AdWords and Facebook use a cost per click (CPC) model to charge marketers. In other words, marketers can set an explicit CPC bid for each ad unit.

In contrast, the disclosed system may convert the CPC number for each particular advertisement to an effective CPM—“eCPM”-bid per thousand impressions.

As used herein, the “eCPM” of an ad unit is the CPC times the amount of clicks per thousand impressions (CPM). Both the CPC and the CPM are directly proportional to the eCPM. In other words, if the CPC increases (and the CPM does not decrease), the eCPM will increase. And if the CPM increases (and the CPC does not decrease), the eCPM will increase. In the preferred embodiment of the disclosed system, the higher the eCPM for a particular ad, the more that ad will run.

For a given cost per click, the actions per thousand (APM) is defined by the expected number of actions in a thousand impressions—a measurable quantity. The higher the number, the better the ad will tend to perform per dollar spent buying these thousand impressions.

As used herein, actions per click (APC), may be equal to the number of acquisitions per click. APM (actions per thousand impressions) and APC are related by the equation:

APM=CPM*APC

In other words, the higher the click per thousand ads (CPM) assuming the APC does not decrease—the more a marketer may be willing to pay per thousand impressions. Similarly, the higher the conversion from the click (i.e., actions per click, or APC))—Assuming the CPM does not decrease—the more a marketer will be willing to pay per impression.

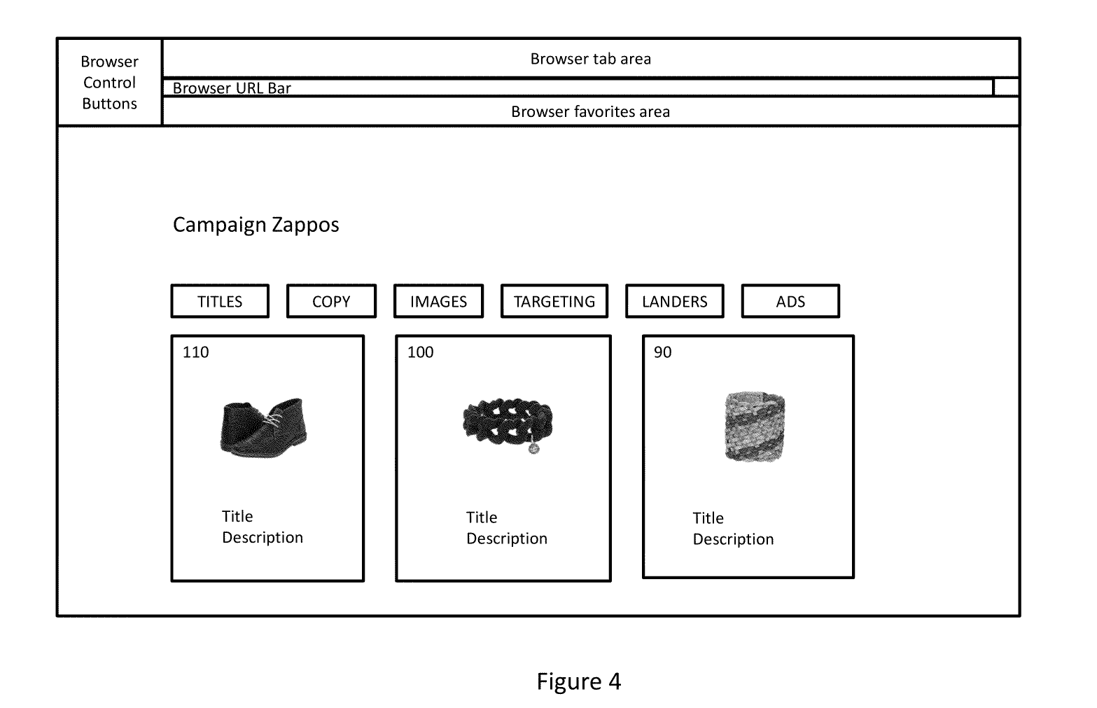

FIG. 4 illustrates one embodiment of an interface showing a selection of the top performing ads in one embodiment of the present disclosed system. In the embodiment illustrated in FIG. 4, each ad has a score measured in APM—Actions per thousand impressions—as defined above. As shown, an ad with a score of 110 win perform 10% better for the advertiser than an ad with the baseline score of 100 on a set of 1,000 impressions. Similarly, an ad with a score of 90 will perform 10% worse than the baseline.

Again there are two, equally effective ways to increase performance per thousand: you can get a better click through rate (CPM), or you can get a better performance from the click. The product of these two numbers is the overall performance number APM.

### Scoring Individual Components

The disclosed system offers several possible ways to score an advertisement. In one embodiment, there is a single “basemark ad” consisting of a choice of 5 of the aforementioned a d components. This ad would be one of the highest performing ads at a given moment, for the campaign as a whole (not restricted to a specific subset of ads in the campaign). By definition, the score for that ad and for all of its ad components would be 100.

In this embodiment, the ad could be modified by replacing any of the ad's components with a substitute component For example, a separate image other than the original baseline image could be substituted, and the performance of the ad could then be measured using that alternative image. The new performance score would then apply to that specific image.

A similar scoring technique could be applied to any other component in the system. Alternatively, multiple baseline ads could be defined and an average score used to score any individual component.

### Using Score to Optimize Bidding

As indicated above, self-service interfaces such as Google Adwords and Facebook allow the marketer to specify a bid cost per click. Given at least two different ads, the disclosed system allows a determination of an optimized bid to make for each particular CPC for any given advertisement.

Ideally, a marketer chooses the CPC to bid on each ad so that each ad has the same performance per dollar spent. If this were not the case, then one ad might produce more acquisitions than another ad, per dollar spent. That is not an optimal situation since it would be more efficient to allocate a dollar towards the more efficient ad.

In one embodiment, the present system may choose any ad at random, to use as the starting point. The system begins running this ad (for example, by placing it on various web pages on the Internet) with a fixed CPC, which may be called “CPC1”.The chosen ad win have a APM of “APM1”, and a APC of “APC1”. The Actions per dollar, (“APD1”)of the ad unit is determined by the equation:

APD1=APC1/CPC1

Ideally, all APDs are the same; in that case, the following is true:

APD1=APD2=APC2/APC2

Rearranging terms,

$$\begin{matrix}CPC 1 I CPC 2 = APC 1 I APC 2 \\ = ( APM 1 / CPM 1 ) I ( APM 2 / CPM 2 )\end{matrix}$$

In one embodiment, the disclosed system uses these equations to determine an optimized CPC to bid on any given ad.

### EXAMPLE OF OPTIMIZED BIDDING

The following is an example of the determination of optimized CPC in one embodiment of the disclosed system:

Ad1 has a CPM of 2 and a APC of 0.140. In other words, every click for Ad1 is expected to generate 0.14 conversions. (In this example, the desired action is a conversion.) The product of these is APM1=0.28. Every thousand impressions generates two clicks, which generate 0.28 conversions.

Ad2 has a CPM of 0.5 and a APC of 0.17. In other words, clicks on Ad2 generate 21% more conversions (0.17I.14) than Ad1. But Ad2 has only a quarter of Ad1's click-through rate. The product of these is APM2=0.085. Every thousand impressions of Ad2 generate only 0.085 conversions.

A rational marketer bidding on a CPM basis would be willing to spend 3.29 times as much for Ad1 as the marketer would for Ad2, as the conversions for Ad1 are exactly 3.29 times greater (0.28/0.085)

Marketers generally bid not on a CPM, but on a CPC basis. The disclosed system may determine an optimized CPC In the following manner: Assuming the initial CPC bid of Ad1 (“CPC1”) is 0.50, then an optimized CPC for Ad2 (“CPC2”) is 171.14 more—21% More—or 71 cents (0.5*1.21) as clicks on Ad2 convert that much more.

In this embodiment, the disclosed system can then determine an optimized CPC for every other ad (thereby determining exactly what the marketer should bid for each ad), given the bid on a single ad. In this embodiment, by setting one CPC, other optimized CPCs may be determined by using the ratios of the APCs.

The disclosed system may set one ad as the “baseline” ad and set a CPC for that ad. This may determine the relative CPCs for one or more other ads. If the volume of ads at a given CPC Is insufficient, the CPCs for an ads can be raised by the same percentage. If the volume is more than sufficient, other CPCs can be lowered, each by the same percentage, until the desired volume is reached.

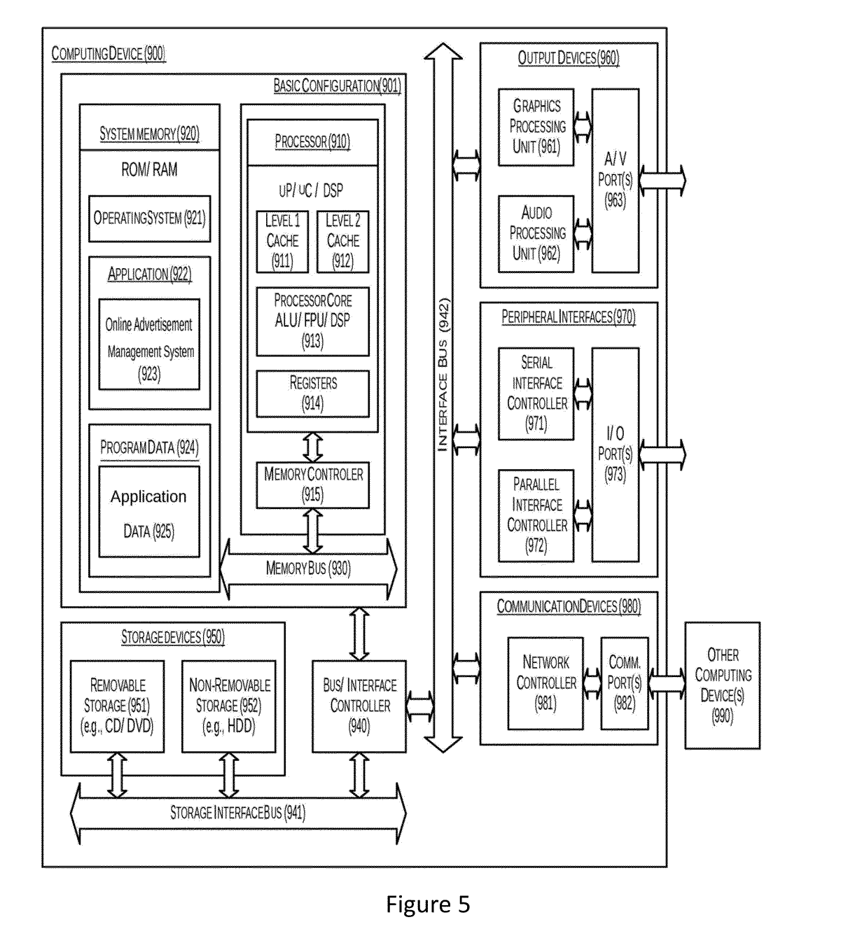

FIG. 5 is a block diagram illustrating an example computing device 900 that may be used to implement one or more embodiments of the software system, in accordance with the present disclosure. In a very basic configuration 901, computing device 900 typically includes one or more processors 910 and system memory 920. A memory bus 930 can be used for communicating between the processor 910 and the system memory 920.

Depending on the desired configuration, processor 910 can be of any type including but not limited to a microprocessor (pP), a microcontroller (pC), a digital signal processor (DSP), or any combination thereof. Processor 910 can include one more levels of caching, such as a level one cache 911 and a level two cache 912, a processor core 913, and registers 914. The processor core 913 can include an arithmetic logic unit (ALU), a floating point unit (FPU), a digital signal processing core (DSP Core), or any combination thereof. A memory controller 915 can also be used with the processor 910, or in some implementations the memory controller 915 can be an internal part of the processor 910.

Depending on the desired configuration, the system memory 920 can be of any type including but not limited to volatile memory (such as RAM), non-volatile memory (such as ROM, flash memory, etc.) or any combination thereof. System memory 920 typically includes an operating system 921, one or more applications 922, and program data 924. Application 922 may include online advertisement management system 923, in accordance with the present disclosure. Program Data 924 may include advertising data 925 that may be useful as has been further described above. In some embodiments, application 922 can be arranged to operate with program data 924 on an operating system 921 such that operation of a system may be facilitated on general purpose computers.

Computing device 900 can have additional features or functionality, and additional interfaces to facilitate communications between the basic configuration 901 and any required devices and interfaces. For example, a bus/interface controller 940 can be used to facilitate communications between the basic configuration 901 and one or more data storage devices 950 via a storage interface bus 941. The data storage devices 950 can be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media (or computer-readable medium) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media can be part of device 900.

Computing device 900 can also include an interface bus 942 for facilitating communication from various interface devices (e.g., output interfaces, peripheral interfaces, and communication interfaces) to the basic configuration 901 via the bus/interface controller 940. Example output devices 960 include a graphics processing unit 961 and an audio processing unit 962, which can be configured to communicate to various external devices such as a display or speakers via one or more AN ports 963.

Example peripheral interfaces 970 include a serial interface controller 971 or a parallel interface controller 972, which can be configured to communicate with external devices such as input devices (e.g., keyboard, mouse, pen, voice input device, touch input device, etc.) or other peripheral devices (e.g., printer, scanner, etc.) via one or more I/O ports 973.

An example communication device 980 includes a network controller 981, which can be arranged to facilitate communications with one or more other computing devices 990 over a network communication via one or more communication ports 982. The communication link is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 900 can be implemented as a portion of a small-form factor portable (or mobile) computer such as a cell phone, a personal data assistant (PDA), a personal media player device, a wireless web-watch device, a personal headset device, an application specific device, or a hybrid device that include any of the above functions. Computing device 900 can also be implemented as a personal computer including both laptop computer and non-laptop computer configurations.

The invention has been described with reference to several embodiments which each incorporate aspects of the invention. However, the invention is not limited to the particular embodiments described. Many other embodiments are possible without deviating from the spirit and scope of the invention. Still further, individual aspects of the several embodiments may be combined in combinations in addition to those particular combinations described herein. The limits of time and space prevent an exhaustive disclosure that describes every combination of features encompassed by the invention. Rather, the scope of the invention is limited only to the claims appended to this specification.

The invention is:

1. A system for online advertising, comprising:
an identification module to identify a plurality of ad components, each ad component comprising an element of a same online advertisement;
a scoring module to score each ad component in the plurality of ad components, each score being based on a desirability of that ad component; and
a pricing module to assign a price for the online advertisement, the price being based on the scores of the ad components in the plurality of ad components.

2. The system recited in claim 1, wherein the plurality of ad components comprise at least two selected from a group, the group comprising at least a title; ad copy; an image; a target group; and a destination.

3. The system recited in claim 2, wherein the title comprises a textual identifier for the online advertisement.

4. The system recited in claim 2, wherein the ad copy comprises textual content for the online advertisement.

5. The system recited in claim 2, wherein the image comprises one or more graphical elements elements related to the online advertisement.

6. The system recited in claim 2, wherein the target group comprises demographic information.

7. The system recited in claim 2, wherein the destination comprises a Uniform Resource Identifier for a location to which the online advertisement leads.

8. A method for online advertising, comprising:
identifying a plurality of ad components, each ad component comprising an element of a same online advertisement;
scoring each ad component in the plurality of ad components, each score being based on a desirability of that ad component; and
pricing the online advertisement, the price being based on the scores of the ad components in the plurality of ad components.

9. The method recited in claim 8, wherein the plurality of ad components comprise at least two selected from a group, the group comprising at least a title; ad copy; an image; a target group; and a destination.

10. The method recited in claim 9, wherein the title comprises a textual identifier for the online advertisement.

11. The method recited in claim 9, wherein the ad copy comprises textual content for the online advertisement.

12. The method recited in claim 9, wherein the image comprises one or more graphical elements elements related to the online advertisement.

13. The method recited in claim 9, wherein the target group comprises demographic information.

14. The method recited in claim 9, wherein the destination comprises a Uniform Resource Identifier for a location to which the online advertisement leads.
